(19) United States
(12) Patent Application Publication
(10) Pub. No.: US 2025/0349176 A1
(43) Pub. Date: Nov. 13, 2025

(54) GAMING ESTABLISHMENT ACCOUNT CREATION FROM GAMING ESTABLISHMENT CREDIT ACCOUNT

(71) Applicant: IGT, Las Vegas, NV (US)

(72) Inventors: Kevin Higgins, Reno, NV (US); Jeffery Shepherd, Reno, NV (US)

(21) Appl. No.: 18/658,488

(22) Filed: May 8, 2024

(51) Int. Cl. G07F 17/32; G06Q 50/34

(52) U.S. Cl. CPC G07F 17/3239; G06Q 50/34; G07F 17/3244; G07F 17/3241

(57) ABSTRACT

Systems and methods that enable the creation of a gaming establishment account maintained by a gaming establishment fund management system based on a separately created gaming establishment credit account maintained by an independently operating gaming establishment credit system.

### BACKGROUND

In various embodiments, the systems and methods of the present disclosure enable the creation of a gaming establishment account maintained by a gaming establishment fund management system based on a separately created gaming establishment credit account maintained by an independently operating gaming establishment credit system.

Casinos are associated with multiple different channels of commerce including gaming activities (e.g., wagers on plays of games at electronic gaming machines and gaming tables) and non-gaming activities (e.g., making retail purchases at point-of-sale terminals throughout the casino).

### BRIEF DESCRIPTION OF THE SEVERAL VIEWS OF THE DRAWINGS

FIG. 1 is an example configuration of the architecture of a plurality of different components of the system of the present disclosure.

FIG. 2 is a flow chart of an example process for operating a system including various components that operate to create a cashless wagering account in association with the creation of a gaming establishment credit account.

FIG. 3 is a flow chart of an example process for operating a system including various components that operate to create a cashless wagering account in association with an occurrence of a triggering event and based on the creation of a gaming establishment credit account.

FIG. 4 is a flow chart of an example process for operating a system including various components that operate to facilitate a bulk creation multiple cashless wagering accounts in association with the creation of multiple gaming establishment credit accounts.

### DETAILED DESCRIPTION

In various embodiments, the systems and methods of the present disclosure enable the creation of a gaming establishment account maintained by a gaming establishment fund management system based on a separately created gaming establishment credit account maintained by an independently operating gaming establishment credit system.

In certain embodiments, the system of the present disclosure creates a gaming establishment account, such as a cashless wagering account, to be maintained by a gaming establishment fund management system in association with a gaming establishment credit account and/or a gaming establishment marker (drawn from such a gaming establishment credit account) independently created by or otherwise maintained by a gaming establishment credit system. In certain such embodiments, upon an individual account creation event, such as a user whom has a gaming establishment credit account and/or a gaming establishment marker requesting a creation of a cashless wagering account, one or more components of the system operate with one or more components of a gaming establishment credit system to retrieve various information associated with the user to potentially create the requested cashless wagering account. In certain other embodiments, upon a bulk account creation event, such as a determination to create multiple cashless wagering accounts for multiple users whom each have a gaming establishment credit account and/or a gaming establishment marker, one or more components of the system operate with one or more components of a gaming establishment credit system to retrieve various information associated with these users to potentially create multiple cashless wagering accounts. In these embodiments, since certain regulations dictate that a first set of data must be collected from a user to extend gaming establishment credit to that user and further since certain regulations dictate that a second set of data must be collected from a user to enroll that user in a cashless wagering account, to open a cashless wagering account for a user, the system of the present disclosure utilizes certain data previously provided by the user in association with the creation of a gaming establishment credit account (i.e., a line of credit extended to a user) and/or the extension of a gaming establishment marker to that user. In other words, given the amount of overlapping data required to be collected between a gaming establishment credit account and a cashless wagering account and given the regulatory required tasks placed on a user to open each of a gaming establishment credit account and a cashless wagering account, the system eliminates the redundancy in a user submitting the same information repeatedly and performing the same required task repeatedly. Such an automatic enrollment in one gaming establishment account, such as a cashless wagering account, based on data previously procured from a user in association with enrolling in another gaming establishment account, such as a gaming establishment credit account, reduces (or eliminates) the relatively complex and laborious process otherwise placed on users (which discourages users from signing up for such accounts), gaming establishment personnel and gaming establishment systems tasked with opening these various accounts.

More specifically, in certain instances, to set up a cashless wagering account with a gaming establishment, certain jurisdictional regulations require that a user must provide various identifying information, such as a name, an address, a date of birth, a portion of a government issued social security number (e.g., the last four digits), and an acknowledgment of a set of rules associated with the cashless wagering account (e.g., by providing a signature or other such indication that the user has read and agrees to the set of rules associated with the cashless wagering account). In addition to the user providing various identifying information, before enabling a user access to such a cashless wagering account, gaming establishment personnel at a gaming establishment service desk must verify the user's identity, such as by verifying that the user is in fact the person pictured on a government issued identification, such as a driver's license or passport, that the user presents to the gaming establishment personnel. This process is time consuming for the user (whom has to seek out the gaming establishment service desk) and potentially unsafe for gaming establishment personnel (whom has to come in close personal contact with dozens of users to review the picture identification documents provided by such users). Moreover, this process is susceptible to violation of such jurisdictional regulations on account of gaming establishment personnel error which may occur if the gaming establishment personnel at a gaming establishment service desk is rushed or otherwise distracted and fails to fully review the presented government issued identification and/or if poor lighting conditions at the gaming establishment service desk hinder the gaming establishment personnel's ability to properly review the government issued identification.

Moreover, in certain instances, to set up a gaming establishment credit account or line of credit, certain jurisdictional regulations require that a user must provide various identifying information, such as a name, an address, a copy of the user's signature, a document of credit worthiness, and an acknowledgment of a set of rules, such as an authorized credit limit, associated with the gaming establishment credit account (e.g., by providing a signature or other such indication that the user has read and agrees to the set of rules associated with the gaming establishment credit account). In addition to the user providing various identifying information (and, in certain instances, providing additional information, such as a date of birth and/or a portion of a government issued social security number (e.g., the last four digits) to enable a credit check to be performed), before extending any credit to the user, gaming establishment personnel at a gaming establishment service desk must verify the user's identity, such as by verifying that the user is in fact the person pictured on a government issued identification, such as a driver's license or passport, that the user presents to the gaming establishment personnel. Gaming establishment personnel must also collect certain information from the government issued identification (e.g., a type of identification credential, a credential number, an expiration date of the credential) and input such information, along with information regarding the verification (e.g., a date the user provided credential was examined), into a gaming establishment personnel interface of a gaming establishment credit system. Similar to the opening of a cashless wagering account, this process is time consuming for the user (whom has to seek out the gaming establishment service desk) and potentially unsafe for gaming establishment personnel (whom has to come in close personal contact with dozens of users to review the picture identification documents provided by such users). Moreover and also similar to the opening of a cashless wagering account, this process is susceptible to violation of such jurisdictional regulations on account of gaming establishment personnel error which may occur if the gaming establishment personnel at a gaming establishment service desk is rushed or otherwise distracted and fails to fully review the presented government issued identification and/or if poor lighting conditions at the gaming establishment service desk hinder the gaming establishment personnel's ability to properly review the government issued identification.

Accordingly, to minimize the amount of time users and gaming establishment personnel need to interact with each other, to minimize the amount of processing resources dedicated to collecting the same information multiple times as well as to reduce the quantity of instances that errors may occur in collecting certain information required by certain jurisdictions, the system of the present disclosure utilizes information previously collected by one component, such as a component of a gaming establishment credit system, in association with the jurisdictional requirement to collect the same (or similar) information by another component, such as a component of a gaming establishment cashless wagering system. That is, based on the amount of overlap involved in information that needs to be collected to enroll a user in a cashless wagering account and separately enroll a user for a gaming establishment credit account (and/or issue a gaming establishment in association with the gaming establishment credit account) and further based on the lack of communication between components that maintain such accounts (which leads to the same user having to input the same information multiple times), the system of the present disclosure harnesses a single input of certain information to enable multiple components to operate independently to achieve different outcomes based on the same inputted information. In other words, in certain instances, the system leverages a gaming establishment credit enrollment process to automate enrolling users into cashless wagering accounts (and/or other types of gaming establishment accounts) as the data requirements for enrolling for a cashless wagering account are relatively close to the data requirements for enrolling for a gaming establishment credit account. Such a configuration results in a more efficient system in which enrolling (or having enrolled) for one gaming establishment account causes the automatic sharing of certain information necessary to enroll for another gaming establishment account which certain users would not otherwise undertake (and not avail themselves of certain benefits realized via the employment of such a gaming establishment account).

In certain embodiments, once the gaming establishment account, such as the cashless wagering account, is created, the system enables such an account to be utilized to transfer funds to one or more gaming establishment devices, such as one or more electronic gaming machines. As such and in certain embodiments, the employment of certain information associated with a user's gaming establishment credit account to create a cashless wagering account enables a transfer of funds from a gaming establishment credit system to the cashless wagering account and then to a balance of a gaming establishment device (e.g., an electronic gaming machine) without the use of cash. Since certain gaming establishment patrons are uncomfortable venturing into a gaming establishment with large amounts of cash, the system enables a user access to an amount of funds from a gaming establishment credit account (via the automatically created cashless wagering account) without the need to handle cash. Such reduction in the use of cash at a gaming establishment provides a relatively more secure environment for a user (via reducing or eliminating a user carrying cash on their person and thus diminishing the risks that such cash may be lost or stolen), overcomes various health concerns associated with cash-based transactions and cashless ticket voucher-based transactions (e.g., protecting patrons from using forms of currency and/or paper cashless ticket vouchers that act as transmission vehicles for contagions), and benefits the gaming establishment by reducing the use of certain kiosks that accept cash (e.g., reducing the wear and tear on such devices and prolonging the operational life on these devices).

Additionally, by reducing the amount of cash transactions in a gaming establishment via enabling the enrollment in a cashless wagering account from the use of gaming establishment credit accounts and/or gaming establishment markers, the system reduces or eliminates human errors which often occur when cash is distributed at gaming establishment interfaces, such as casino desks and/or cashless ticket vouchers are purchased with an amount of cash at gaming establishment interfaces, such as casino desks. Specifically, eliminating gaming establishment personnel from distributing cash and/or issuing ticket vouchers in exchange for amounts of cash not only protects the user (if the gaming establishment personnel provides the gaming establishment patron a lower amount of cash and/or a lower valued cashless ticket voucher than the patron deserves) but also protects the gaming establishment (if the gaming establishment personnel inadvertently or fraudulently provides the patron a higher amount of cash and/or or a higher valued cashless ticket voucher than the patron deserves). As such, the system of the present disclosure provides an alternative, non-cash-based and non-ticket voucher-based option for a gaming establishment patron to access funds at a gaming establishment device without having to undertake relatively complex and laborious activities multiple times.

It should be appreciated that while described as creating a gaming establishment account, such as a cashless wagering account, based on (and employing certain information associated with) the creation of a gaming establishment credit account and/or the activation of a gaming establishment marker, in certain embodiments, the present disclosure additionally or alternatively operates to create a gaming establishment credit account based on (and employing certain information associated with) the creation of a gaming establishment account, such as a cashless wagering account. In these embodiments, the system harnesses a single input of certain information provided during a cashless wagering account enrollment process to automate enrolling one or more users into one or more gaming establishment credit accounts maintained by a separately operating gaming establishment credit system (and thus reduces or eliminates the same user having to input the same information multiple times).

It should be further appreciated that in addition to (or alternative from) creating a gaming establishment account, such as a cashless wagering account, based on (and employing certain information associated with) the creation of a gaming establishment credit account and/or the activation of a gaming establishment marker, the present disclosure includes creating a gaming establishment account, such as a cashless wagering account, based on (and employing certain information associated with) the creation of a gaming establishment front money account. In these embodiments, the system harnesses a single input of certain information provided during a front money account enrollment process to automate enrolling one or more users into one or more cashless wagering accounts (and/or other gaming establishment accounts) maintained by a separately operating gaming establishment fund management system (and thus reduces or eliminates the same user having to input the same information multiple times).

It should also be appreciated that while described as the creation of a gaming establishment credit account and the activation of a gaming establishment marker from that created gaming establishment credit account are two separate events, in certain embodiments, the creation of a gaming establishment credit account and the activation of a gaming establishment marker from that created gaming establishment credit account are a single event. That is, while described as an occurrence of a gaming establishment account creation event being separate from an occurrence a gaming establishment marker creation event, in certain embodiments, the gaming establishment account creation event and the gaming establishment marker creation event are the same event (e.g., a user applies for a marker and in doing so, applies for a credit account to fund the marker).

In various embodiments, the present disclosure is directed to a system including or otherwise in communication with various components and/or sub-systems that operate together to cause an automatic creation of a gaming establishment account, such as a cashless wagering account, based on a created gaming establishment credit account and/or an activation of a gaming establishment marker. In these embodiments, the collection of components that are part of the system (or otherwise operate with one or more components of the system) facilitate such automatic account creations as well as the transfer of funds from a gaming establishment credit system to a gaming establishment account and then to a gaming establishment device.

In certain embodiments, the present disclosure is directed to a gaming establishment fund management system including various sub-systems that are each associated with or otherwise maintain one or more electronic or virtual accounts. In these embodiments, the various accounts maintained for a user collectively form a resort or enterprise account (i.e., a gaming establishment fund management account) for the user. That is, the collection of cashless wagering accounts (e.g. cashless gaming establishment wagering wallets, cashless sports wagering wallets and/or cashless mobile wagering wallets) and gaming establishment retail accounts (e.g., gaming establishment retail wallets) associated with or otherwise maintained for a user (one or more of which are automatically created in association with data employed in the creation of a gaming establishment credit account) individually and/or collectively form a resort or enterprise account (i.e., an integrated resort or gaming establishment fund management wallet) that the user may access to transfer funds and/or view balance information amongst the various accounts associated with or otherwise maintained for the user.

In various embodiments, the gaming establishment fund management system includes or is otherwise associated with one or more cashless wagering systems. Each cashless wagering system is associated with or otherwise maintain one or more cashless wagering accounts (one, more or all of which are automatically created based on data employed in association with a gaming establishment credit account or a gaming establishment marker).

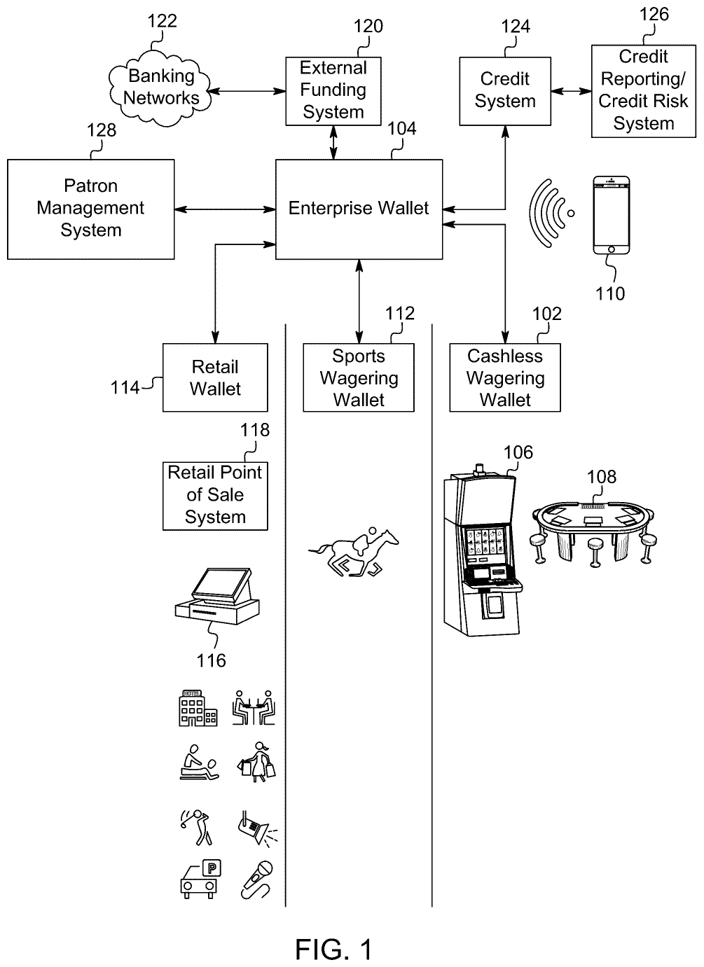

In certain embodiments, the gaming establishment fund management system includes or is otherwise in communication with a first cashless wagering system that maintains a first cashless wagering account (in certain instances created, as described below, in association with a previously created gaming establishment credit account and/or an activation of a gaming establishment marker). In these embodiments, a user, such as a player of an electronic gaming machine (“EGM”), utilizes a mobile device application running on a mobile device and/or a physical instrument (e.g., a smart card or a user issued magnetic striped card which the user utilizes via inserting the card into a component of a gaming establishment patron management system associated with a gaming establishment device) to facilitate the electronic transfer of any funds between this first cashless wagering account and a gaming establishment device, such as a component of a gaming table and/or an EGM (including, but not limited to, a slot machine, a video poker machine, a video lottery terminal, a terminal associated with an electronic table game, a terminal associated with a live table game, a video keno machine, a video bingo, and/or a sports betting terminal (that offers wagering games and/or sports betting opportunities)). For example, as seen in FIG. 1, the gaming establishment fund management system includes a first cashless wagering system (not shown) that maintains a Cashless Wagering Wallet 102 (e.g., a first cashless wagering account) which is in communication with the enterprise wallet 104. In this example, to facilitate the transfer of funds between this cashless wagering account and a credit balance of an EGM 106 and/or a credit balance of a gaming table component (not shown) associated with a gaming table 108, the system utilizes a mobile device 110 running a mobile device application that interfaces with one or more components of the gaming establishment fund management system to enable a user, such as a player of the EGM or a player at the gaming table, access to this first cashless wagering account.

In certain embodiments, the gaming establishment fund management system additionally or alternatively includes or is otherwise in communication with a second cashless wagering system that maintains a second cashless wagering account (in certain instances created, as described below, in association with a previously created gaming establishment credit account and/or the activation of a gaming establishment marker). In these embodiments, funds associated with the second cashless wagering account are utilized to place one or more sporting event wagers and/or wagers placed remote from an EGM and a gaming table. In such embodiments, a user utilizes a mobile device application running on a mobile device and/or a physical instrument (e.g., a smart card or a user issued magnetic striped card which the user utilizes via inserting the card into a kiosk) to facilitate the electronic transfer of any funds between this second cashless wagering account and a credit balance accessible to wager on sporting events and/or games of chance (or games of skill) remote from an EGM and a gaming table. For example, as seen in FIG. 1, the gaming establishment fund management system includes a second cashless wagering system (not shown) that maintains a Sports Wagering Wallet 112 (e.g., a second cashless wagering account) which is in communication with the enterprise wallet 104. In this example, to facilitate the transfer of funds between this cashless wagering account and a credit balance associated with a sporting event wagering system (not shown) and/or a remote wagering system (not shown) to enable the placement of one or more wagers on one or more sporting events and/or one or more games of chance (or games of skill), the system utilizes a mobile device 110 running a mobile device application that interfaces with one or more components of the gaming establishment fund management system to enable, amongst other activities, a user, such as a user remote from the gaming establishment, access to this second cashless wagering account.

In various embodiments, in addition to or an alternative of maintaining one or more cashless wagering accounts via one or more cashless wagering systems, the gaming establishment fund management system includes or is otherwise in communication with one or more gaming establishment retail wallet systems that each maintain one or more gaming establishment retail accounts (in certain instances created, as described below, in association with a previously created gaming establishment credit account and/or an activation of a gaming establishment marker). Such a gaming establishment retail account (e.g., a gaming establishment retail wallet) of a gaming establishment retail wallet system integrates with various retail point-of-sale systems throughout the gaming establishment (or located remote from the gaming establishment, but otherwise associated with the gaming establishment) to enable users to purchase goods and/or services via the user's gaming establishment retail account. For example, as seen in FIG. 1, the gaming establishment fund management system includes a gaming establishment retail wallet system (not shown) that maintains a Retail Wallet 114 (e.g., a gaming establishment retail account) which is in communication with the enterprise wallet 104. In this example, to facilitate the transfer of funds between this gaming establishment retail account and an account associated with a retailer to purchase goods and/or services from the retailer, the system utilizes a retail wallet identity, such as a mobile device 110 running a mobile device application that interfaces with a point-of-sale terminal 116 of a retail point-of-sale system 118 of the retailer and/or a physical instrument (e.g., a smart card or a user issued magnetic striped card which the user utilizes in association with the point-of-sale terminal), and one or more components of the gaming establishment fund management system to enable a user access to this gaming establishment retail account. In other embodiments, the gaming establishment fund management system does not maintain a separate gaming establishment retail account, but rather utilizes the gaming establishment retail wallet system as a transaction coordinator to account for any transactions to purchase goods and/or services from a retailer.

In certain embodiments, a gaming establishment retail account is a retail account associated with a user having a balance or a pre-paid access account which, per current regulations from the U.S. Treasury Department Financial Crimes Enforcement Network (“FinCEN”), cannot be convertible to cash and can only be used for the purchase of goods and/or services. In these embodiments, such a gaming establishment retail account integrates with various retail point-of-sale systems of various retail establishments throughout or otherwise associated with a gaming establishment to enable users to purchase goods and/or services via the user's gaming establishment retail account. Accordingly, in certain embodiments, based on one or more jurisdictional regulations, an amount of funds deposited in a gaming establishment retail account may be used with various retail point-of-sale systems throughout the gaming establishment (or remote from, but otherwise associated with the gaming establishment) to enable users to purchase goods and/or services, but such funds deposited in the gaming establishment retail account cannot be converted to cash or check. In certain other embodiments, based on one or more different jurisdictional regulations, an amount of funds deposited in a gaming establishment retail account, such as an account associated with an identified user, may be used with various retail point-of-sale systems throughout the gaming establishment (or remote from, but otherwise associated with the gaming establishment) to enable users to purchase goods and/or services wherein such funds deposited in the gaming establishment retail account may be converted to or otherwise redeemable for cash or check.

In various embodiments, the system includes or is otherwise in communication with a payment gateway operable to interface with a banking network to communicate with one or more servers of one or more financial institutions that maintain one or more financial institution accounts and implement zero, one or more financial institution protocols, such as banking protocols. In such embodiments, the system includes a payment gateway operable with a banking network and one or more external funding sources (e.g., financial institutions) which maintain one or more external accounts (e.g., financial institution accounts) for a user to enable certain actions, including, but not limited to, balance inquiries, funding source enrollments and/or fund transfers. For example, as seen in FIG. 1, the gaming establishment fund management system that maintains the enterprise wallet 104 is in communication with a payment gateway (i.e., external funding system 120) which is in communication with a network of one or more banks or other financial institutions (i.e., the banking networks 122) which operate to electronically transfer funds between the user's accounts maintained at such banks or financial institutions between one or more of the accounts maintained by the gaming establishment fund management system. In different embodiments, the accounts of the external funding sources include, but are not limited to, one or more checking accounts maintained by one or more financial institutions (e.g., one or more banks and/or credit unions), one or more savings accounts maintained by one or more financial institutions, one or more financial institution accounts, such as a brokerage account, maintained by one or more financial institutions, one or more credit card accounts maintained by one or more financial institutions, one or more debit card accounts maintained by one or more financial institutions, and/or one or more third-party maintained accounts (e.g., one or more PayPal® accounts or Venmo® accounts). It should be appreciated that while illustrated as the gaming establishment fund management system being in communication with one or more external funding sources, in different embodiments, any sub-system of the present disclosure can be in communication with one or more external funding sources. In different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to facilitate the transfer of funds to/from an external account.

In certain embodiments, the gaming establishment fund management system includes or is otherwise in communication with one or more credit systems which each issue the user one or more markers drawn from one or more gaming establishment credit accounts. In addition to issuing markers, one or more components of the credit system enable data procured in association with establishing such credit accounts and/or issuing such markers to be employed by one or more other components to facilitate the automatic creation of one or more gaming establishment accounts, such as one or more cashless wagering accounts. For example, as seen in FIG. 1, the gaming establishment fund management system that maintains the enterprise wallet 104 is in communication with a gaming establishment credit system (i.e., the credit system 124) to facilitate the access of an amount of funds via one or more markers. These markers are accessible to facilitate a transfer of funds from the credit account (i.e., the line of credit) issued by the credit system to, either directly or indirectly through a cashless wagering account, a credit balance of a gaming establishment device, such as an EGM and/or a gaming table. In this example, to facilitate a transfer of funds from the line of credit issued by the credit system to a credit balance of an EGM 106 and/or a gaming table 108a, the system utilizes a mobile device 110 running a mobile device application that interfaces with one or more components of the credit system to enable a user, such as a player of the EGM or a player at the gaming table, access to the issued line of credit. It should be appreciated that while illustrated as the gaming establishment fund management system being in communication with one or more credit systems, in different embodiments, any sub-system described herein can be in communication with one or more credit systems. It should be further appreciated that in different embodiments, the system utilizes a mobile device running a mobile device application, a kiosk, a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment credit system.

In certain embodiments, the gaming establishment fund management system includes or is otherwise in communication with one or more credit reporting/credit risk systems which monitor and report on various accounts associated with the user. For example, as seen in FIG. 1, the credit system 124 is in communication with a credit reporting and risk system 126. These credit reporting and risk systems monitor and report on a credit rating and status of one or more accounts maintained for the user at various funding sources, such as various financial institutions. It should be appreciated that while, in certain embodiments, the gaming establishment fund management system being in communication with one or more credit reporting networks and one or more credit reporting/credit risk systems, in different embodiments, any sub-system of the present disclosure can be in communication with one or more credit reporting/credit risk systems.

In certain embodiments, the gaming establishment fund management system includes or is otherwise in communication with one or more gaming establishment patron management systems that maintain data associated with one or more users, monitor activities at various points of contact associated with the gaming establishment and provides rewards, such as redeemable player tracking points, to such users in association with the monitored activities. For example, as seen in FIG. 1, the gaming establishment fund management system that maintains the enterprise wallet 104 is in communication with a patron management system 128 which maintains one or more databases including information regarding gaming establishment patrons. It should be appreciated that while, in certain embodiments, the gaming establishment fund management system is in communication with one or more gaming establishment patron management systems, in different embodiments, any sub-system of the present disclosure can be in communication with one or more gaming establishment patron management systems. In different embodiments, the system utilizes a mobile device running a mobile device application, a kiosk, an interface of a gaming device (e.g., an interface of an EGM or gaming table component), a service window displayed by a gaming device (e.g., a remote host controlled service window displayed by an EGM), a component of a gaming establishment patron management system, such as a player tracking unit, and/or a gaming establishment interface to interface with the gaming establishment patron management system.

In certain embodiments, the gaming establishment fund management system includes or is otherwise in communication with one or more front money handling systems which each maintain an amount of front money provided by a user in a front money account. For example, the gaming establishment fund management system that maintains the enterprise wallet is in communication with a gaming establishment front money handling system to facilitate the access of an amount of funds via front money provided by the user. Such front money is provided by the user, such as via the user depositing cash, gaming table chips, a personal check, a bank draft, a money order or a wire transfer into a front money account associated with the user. The balance of the front money is drawn down from the front money account (in certain instances via the issuance of markers) and accessible by the front money handling system to (either directly or indirectly through a cashless wagering account) a credit balance of a gaming device, such as an EGM and/or a gaming table and/or to (either directly or indirectly through a gaming establishment retail account) a point-of-sale terminal (or an account associated with the point-of-sale terminal).

In certain embodiments, the system utilizes one mobile device application to interact with the different components of (or in communication with) the gaming establishment fund management system to, amongst other actions, access funds maintained in the different gaming establishment accounts associated with the user. For example, utilizing the same mobile application, a mobile device interacts with both the first cashless wagering system of the gaming establishment fund management system and the gaming establishment retail wallet system of the gaming establishment fund management system. In certain embodiments, the system utilizes multiple mobile device applications to interact with the different components of (or in communication with) the gaming establishment fund management system to, amongst other actions, access funds maintained in the different gaming establishment accounts associated with the user. In certain of these embodiments, the mobile device applications include a location based digital wallet enabled application, such as a Passbook-enabled or Wallet-enabled application, which is accessible when the user enters a gaming establishment. In certain of such embodiments, the mobile device applications are downloaded to the mobile device from an application store. In certain of such embodiments, the mobile device applications are downloaded to the mobile device from one or more websites affiliated with the gaming establishment (which are accessible directly by the user and/or by a link opened when the user scans a QR code).

In certain embodiments, to interact with one or more components of (or in communication with) the system, the system enables a user to pair or link their mobile device to a gaming device, wherein this pairing or linkage between the mobile device and the gaming device occurs via one or more applications being run or executed on the mobile device. In certain such embodiments, the mobile device application prompts the user to cause the mobile device to engage the gaming device or a component of the gaming device (e.g., a slot machine interface board (“SMIB”) or other component of a gaming establishment management system supported by the gaming device), such as prompting the user to tap the mobile device to a player tracking card reader or other designated location(s) of the gaming device. After any required engagement, the mobile device application communicates, via a wireless communication protocol (including, but not limited to: Bluetooth™, Bluetooth™ Low Energy (“BLE”), one or more cellular communication standards (e.g., 3G, 4G, 5G, 6G, LTE), one or more Wi-Fi compatible standards, and one or more short range communication protocols (e.g., a near field communication (“NFC”) protocol), data associated with a requested action. Following the mobile device application communicating, via a wireless communication protocol, data associated with a requested action, the gaming device (or a component of the gaming device, such as a SMIB and/or the mobile device application) proceeds with operating with a component of (or in communication with) the gaming establishment fund management system to log the user into an account maintained by that component (if necessary) and request authorization of the requested action.

It should be appreciated that in different embodiments, in addition to or alternatively from utilizing a mobile device running a mobile device application to, amongst other actions, facilitate the transfer of funds between zero, one or more gaming devices (e.g., an EGM and a gaming table component), zero, one or more gaming establishment accounts (e.g., a cashless wagering account and a gaming establishment retail account), and zero, one or more lines of credit, the system utilizes a kiosk, a gaming device (e.g., an interface of an EGM or gaming table component), a service window displayed by a gaming device (e.g., a remote host controlled service window displayed by an EGM), a display device/input device associated with a seat-level gaming table component, a display device/input device associated with a table-level gaming table component, a display device/input device associated with a mobile gaming table component, a component of a gaming establishment patron management system, such as a player tracking unit, a retail point-of-sale terminal, and/or a gaming establishment interface, such as a casino desk, to, amongst other actions, facilitate the transfer of funds between zero, one or more gaming devices, zero, one or more gaming establishment accounts, and zero, one or more lines of credit. It should be further appreciated that while illustrated in FIG. 1 as using a mobile device running a mobile device application to facilitate the transfer of funds between zero, one or more gaming devices, zero, one or more gaming establishment accounts and zero, one or more lines of credit, as mentioned above, a physical instrument, such as a smart card or a user issued magnetic striped card may additionally or alternatively be utilized to enable a user such access.

In certain embodiments, two or more of the systems, sub-systems and components of the present disclosure may be combined into a single system, sub-system or component. For example, while the credit system and the credit risk system are illustrated as separate components, the credit system and the credit risk system may be combined into a single component operable to interface with the enterprise wallet of the gaming establishment fund management system to facilitate the activation of a gaming establishment marker based on a credit worthiness of a user. It should be further appreciated that while described as funds accessed from an external funding source and/or funds activated from a gaming establishment marker being transferred (directly or indirectly through a gaming establishment account, such as a cashless wagering account) to an EGM, in different embodiments, funds accessed from an external funding source and/or funds activated from a gaming establishment marker may be transferred to any suitable non-EGM gaming establishment device operable to receive funds, such as, but not limited to, a kiosk or a retail point-of-sale terminal associated with a gaming establishment.

In certain embodiments, the system enables a transfer of funds between different accounts maintained by one or more gaming establishment components as well as activations of markers to enable different gaming activities and/or non-gaming activities. In these embodiments, the system employs a service for interfacing with the various components to facilitate balance inquiries and the transfer of funds. In certain embodiments, such a service collects data from various components and utilizes such collected data to provide a singular view of the balances (or a plurality of singular views of different groupings of balances) available. In certain embodiments, such a service additionally or alternatively provides facilities to enforce rules and/or limitations including, but are not limited to, jurisdictional controls, self-imposed limits, state governmental controls and federal governmental controls, wherein the system provides the logic to determine how, and how much, to transfer to satisfy a request for funds while staying within the confines of such rules. In certain embodiments, such a service additionally or alternatively tracks and coalesces transaction history of the interconnected components of the system such that all transactions within the system have a “master” transaction record that ties all of the various fund transfers to a single initiating funds transfer.

In various embodiments, prior to automatically creating a gaming establishment account, such as a cashless wagering account, based on certain data employed in the opening of a gaming establishment credit account, the system enables a user to establish a credit account with a gaming establishment credit system. In certain such embodiments, this includes a user applying for a marker (with or without presenting a check or other bank account information in the event the marker is not paid back by the user) and the credit system approving the marker for up to a set amount of funds.

In certain embodiments, to apply for a marker, the system enables a user with an existing gaming establishment patron management system account, such as a player tracking account (or following such an account being opened, automatically or manually, for a user without a gaming establishment patron management system account) to utilize an interface, such as a mobile device application being executed by a mobile device, a website accessed from a browser, a kiosk and/or a service window displayed by EGM (or other gaming establishment device), to attempt to complete the application through one or more interactive forms. For example, as part of applying for a gaming establishment credit account (and/or activating a marker), the user makes one or more inputs via an interface to provide certain user identifying information (such as, but not limited to, a name, an address, a date of birth, a portion of a government issued social security number (e.g., the last four digits), a copy of a signature and/or a mother's maiden name) and/or certain external account identifying information (such as, but not limited to, an identification of a funding source, and/or an external account number) in the event the marker is not paid back by the user. In certain embodiments, following such information being made available by the user, the system utilizes part or all of such identifying information to operate with a financial institution (or other third-party) to perform one or more Know Your Customer (“KYC”) checks to further validate the information.

In certain embodiments, as part of applying for a gaming establishment credit account and/or activating a marker, the system determines zero, one or more security measures to invoke in association with one or more (or each) transaction that involves funds accessed via the marker. In these embodiments, to prevent unauthorized access to the funds associated with such a marker, the system applies such determined security measures in association with one or more (or each) transaction that attempts to access funds via the marker. In certain embodiments, as part of applying for a gaming establishment credit account and/or activating a marker, the system determines one or more controls or restrictions to associate with the marker wherein if such controls are violated, the system invokes one or more security measures. In these embodiments, to balance the need to prevent unauthorized access to the funds associated with a marker against the need to provide a frictionless experience for users, the system dynamically employs one or more security measures such that certain transactions that trigger the need to employ enhanced security measures and certain transactions that do not trigger the need to employ enhanced security measures. It should be appreciated that an enhanced security measure includes any form of security that was not otherwise associated with the transaction prior to the determination that the nature of the transaction warranted an additional degree of protection to combat any attempted fraud associated with the transaction. For example, if a user is required to enter a personal identification number (“PIN”), provide a signature and/or present a biometric identifier for each attempted transfer of funds from a credit account regardless of any determination that the nature of the transaction warrants any additional degree of protection to combat any attempted fraud associated with the transaction, such a PIN, signature and/or biometric identifier would not qualify as an enhanced security measure. In another example, if a user is not required to enter a PIN, provide a signature and/or present a biometric identifier for each attempted transfer of funds from a credit account but following a determination that the nature of the transaction warrants requiring the user to enter a PIN, provide a signature and/or present a biometric identifier an as an additional degree of protection to combat any attempted fraud associated with the transaction, such a PIN, signature and/or biometric identifier would qualify as an enhanced security measure.

Following the establishment of the credit account, the system enables the user to utilize any suitable interface to view information about one or more available markers (e.g., an available amount of funds associated with the credit account and/or an amount of funds associated with the marker previously accessed). In addition to enabling the user to view information about one or more available markers, the system enables the user to activate all or part of the available amount of funds associated with an available marker. In these embodiments, the system enables the user to make one or more inputs regarding the requested access to the marker, such as, but not limited to, one or more inputs to indicate an amount of funds to be accessed via the marker, one or more inputs to approve the indicated amount of funds to be accessed via the marker, and/or one or more inputs to confirm the accessing of the marker.

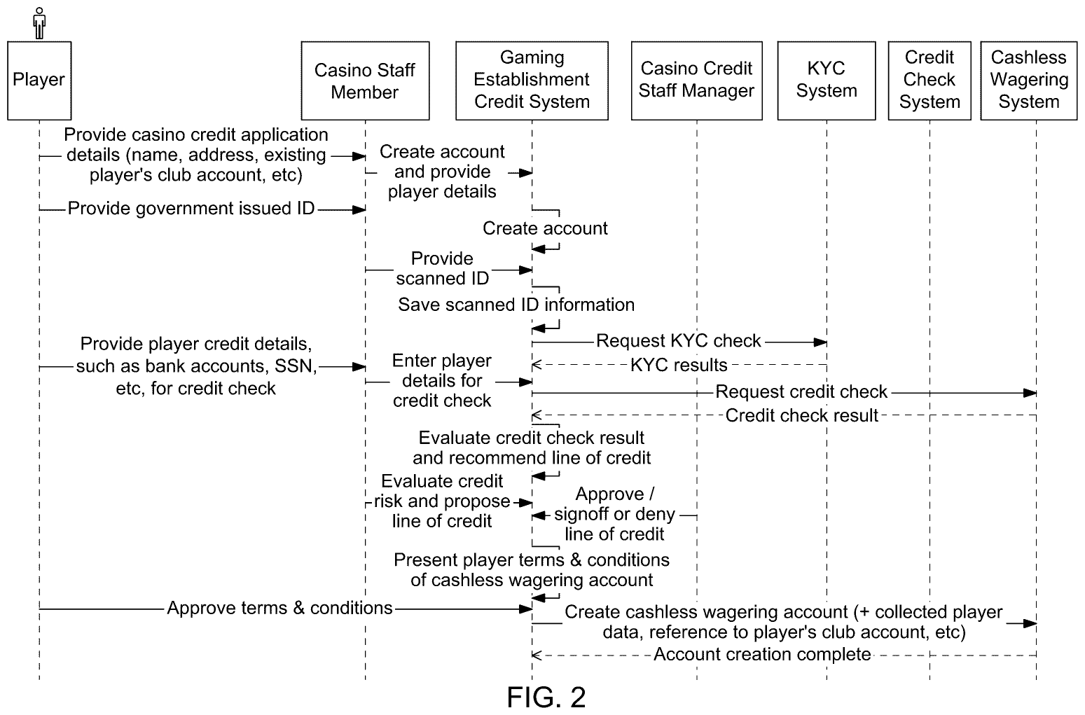

In certain embodiments, as part of the process of establishing a gaming establishment credit account and/or accessing a marker drawn from an established gaming establishment credit account, the system utilizes part or all of the information employed to establish the credit account and/or access the marker to create one or more separate and distinct gaming establishment accounts, such as a cashless wagering account. In these embodiments, the gaming establishment credit system coordinates with the cashless wagering system (and/or other components of the gaming establishment fund management system) during the gaming establishment credit account signup process and/or marker activation process to also create a cashless wagering account for the user. That is, in certain instances, a gaming establishment account creation event occurs based on a gaming establishment credit account creation event (and/or a gaming establishment marker creation event) and if so, the system operates to automatically initiate the creation of a non-marker gaming establishment account, such as a cashless wagering account, subject to zero, one or more additional steps required of the user (e.g., the user separately acknowledging that they are signing up for a cashless wagering account and accepting the terms and conditions required for such an account). For example, as seen in FIG. 2 (which illustrates certain interactions involving a user, such as a player that provides various information to a casino staff member, to apply for and, subject to approval from a casino credit staff manager, be granted casino credit from a gaming establishment credit system, a KYC service provider, a credit check system and a cashless wagering system), certain embodiments of the present disclosure enable the creation of a cashless wagering account in association with a user's enrollment for a gaming establishment credit account and/or the activation of a gaming establishment marker.

It should be appreciated that the order of certain of the processes involved with the creation of the cashless wagering account based on the creation of the gaming establishment credit account may differ. For example, the cashless wagering account creation event illustrated in FIG. 2 could alternatively occur at any point in time once the proper information has been collected from the user and validated via one or more validation services (e.g., the KYC service provider). In another example, the system creates a user's cashless wagering account after the KYC check is complete but before (or contemporaneously with) the completion of the gaming establishment credit account.

It should also be appreciated that certain of the processes involved with the creation of the cashless wagering account based on the creation of the gaming establishment credit account may not be required by the jurisdiction in which the system of the present disclosure operates. For example, if the user does not need to accept the terms and conditions to create a cashless wagering account and they only have to accept the terms and conditions to move the cashless wagering account from a disabled or inactive state to an active or enabled state, such an acceptance of the terms and conditions is not required as part of the automatic opening of the cashless wagering account based on the creation of the gaming establishment credit account. In another example, in certain jurisdictions in which gaming establishment personnel are only required to validate a government issued ID presented by the user, no KYC check is required and the system proceeds with the automatic opening of the cashless wagering account based on the creation of the gaming establishment credit account without any KYC check provided.

It should be further appreciated that certain of the processes involved with the creation of the cashless wagering account based on the creation of the gaming establishment credit account may be at least partially manually accomplished by gaming establishment personnel. For example, gaming establishment personnel may manually take information provided by the user, enter the obtained information into a credit check system, record the credit check result, and manually input the result in a gaming establishment credit application to grant the user a line of credit (which is then used to automatically create a cashless wagering account). In another example, gaming establishment personnel may manually take information provided by the user and grant the user a line of credit (which is then used to automatically create a cashless wagering account).

In certain embodiments, following the establishment of a gaming establishment credit account and/or the activation of a marker drawn from that gaming establishment credit account, the system utilizes part or all of the information employed from the establishment of the credit account and/or the activation of the marker to create one or more separate and distinct gaming establishment accounts, such as a cashless wagering account. In these embodiments, the gaming establishment credit system coordinates with the cashless wagering system (and/or other components of the gaming establishment fund management system) after the gaming establishment credit account signup process and/or the marker activation process to also create a cashless wagering account for the user. That is, in certain instances, a gaming establishment account creation event occurs after (but based on information from) a gaming establishment credit account creation event and/or a gaming establishment marker creation event such that the system operates to automatically initiate the creation of a non-marker gaming establishment account, such as a cashless wagering account, subject to zero, one or more additional steps required of the user (e.g., the user separately acknowledging that they are signing up for a cashless wagering account and accepting the terms and conditions required for such an account).

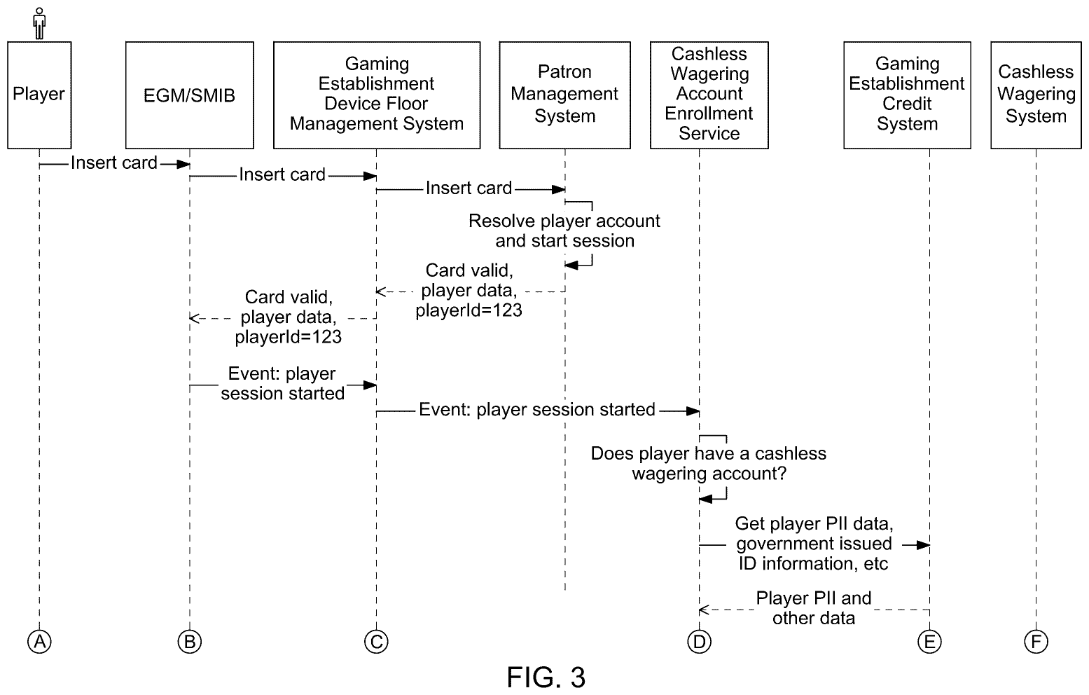

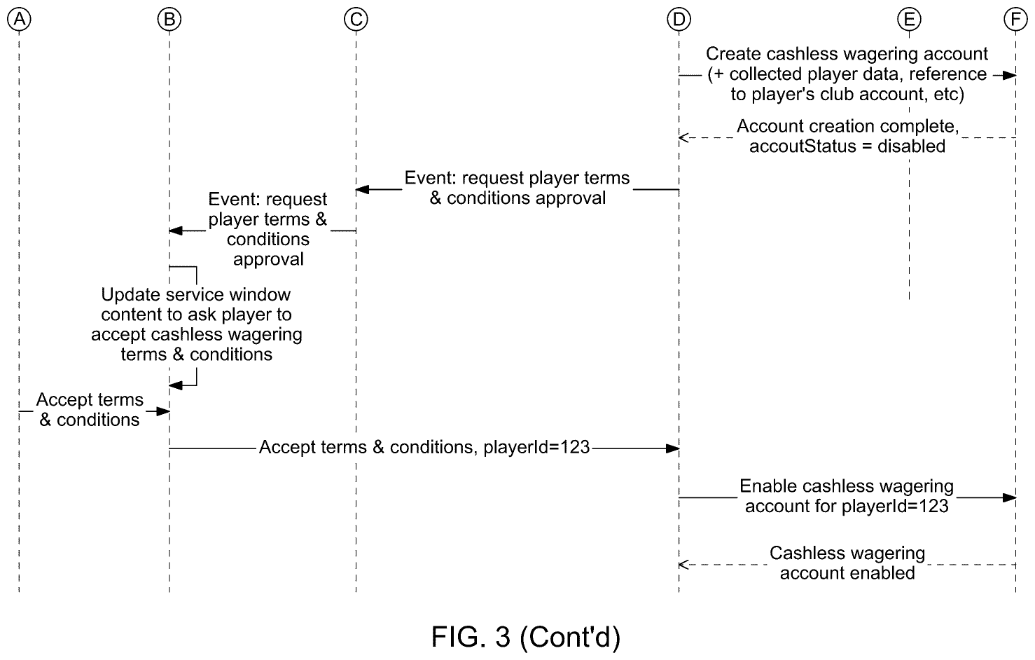

In certain embodiments, following the establishment of a gaming establishment credit account and/or the activation of a marker from that gaming establishment credit account and responsive to an occurrence of a triggering event that separately occurs in association with a gaming establishment device, the system utilizes part or all of the information employed from the establishment of the gaming establishment credit account and/or the activation of the marker drawn from the credit account to create one or more separate and distinct gaming establishment accounts, such as a cashless wagering account. In these embodiments, the gaming establishment credit system coordinates with the cashless wagering system (and/or other components of the gaming establishment fund management system) after the gaming establishment credit account signup process and/or the activation of a gaming establishment marker drawn from the gaming establishment account and based on a separate account creation event to create a cashless wagering account for the user. For example, a cashless wagering account creation event occurs when a user previously enrolled for a gaming establishment credit account shows up at a gaming establishment and starts a wagering session at an EGM. In this example, when the user starts a wagering session at an EGM, the system recognizes that the user enrolled for a gaming establishment credit account does not have a cashless wagering account such that the system automatically creates a cashless wagering account for the user employing certain information previously collected from the user when the user registered for a gaming establishment credit account. As seen in this example, in certain instances, a gaming establishment account creation event occurs separate from (but based on information associated with) a gaming establishment credit account creation event and a gaming establishment marker creation event such that the system operates to automatically initiate the creation of a non-marker gaming establishment account, such as a cashless wagering account, subject to zero, one or more additional steps required of the user (e.g., the user separately acknowledging that they are signing up for a cashless wagering account and accepting the terms and conditions required for such an account). As such and as seen in FIG. 3 (which illustrates certain interactions involving a user, such as a player at an EGM that has identified themselves to a gaming establishment patron management system in association with a session at the EGM, a gaming establishment device floor management system operating with the EGM (and/or a SMIB associated with the EGM) and the gaming establishment patron management system, a cashless wagering account enrollment service, a gaming establishment credit system, and a cashless wagering system), certain embodiments enable the creation of a cashless wagering account based on a triggering event that occurs in association with a gaming establishment device (e.g., the EGM and/or SMIB associated with the EGM) and which employs certain data previously obtained in association with a user's enrollment for a gaming establishment marker.

In certain embodiments, following the establishment of a gaming establishment credit account and/or the activation of a marker from that gaming establishment credit account and responsive to an occurrence of a triggering event that separately occurs independent of any gaming device, the system utilizes part or all of the information employed from the establishment of the gaming establishment credit account and/or the activation of a marker to create one or more separate and distinct gaming establishment accounts, such as a cashless wagering account. In these embodiments, the gaming establishment credit system coordinates with the cashless wagering system (and/or other components of the gaming establishment fund management system) after the gaming establishment credit account signup process and/or after the activation of the marker and based on a separate account creation event to create a cashless wagering account for the user. For example, a cashless wagering account creation event occurs when a user previously enrolled for a gaming establishment credit account schedules a hotel room reservation. In this example, when the user makes one or more inputs indicative of a future use of a cashless wagering account (i.e., the scheduling of a hotel room reservation), the system recognizes that the user enrolled for a gaming establishment credit account does not have a cashless wagering account (which the system anticipates the user will need) such that the system automatically creates a cashless wagering account for the user using information previously collected from the user when they registered for their gaming establishment credit account. In another example, a cashless wagering account creation event occurs when a user whom previously activated a gaming establishment marker makes a purchase at a gaming establishment restaurant or retail establishment and uses a gaming establishment retail account to facilitate the purchase (or alternatively swipes their player tracking card to earn points for their purchase or redeem points for their purchase). As seen in these examples, in certain instances, a gaming establishment account creation event occurs separate from (but based on information associated with) a gaming establishment credit account creation event and a gaming establishment marker creation event such that the system operates to automatically initiate the creation of a non-marker gaming establishment account, such as a cashless wagering account, subject to zero, one or more additional steps required of the user (e.g., the user separately acknowledging that they are signing up for a cashless wagering account and accepting the terms and conditions required for such an account).

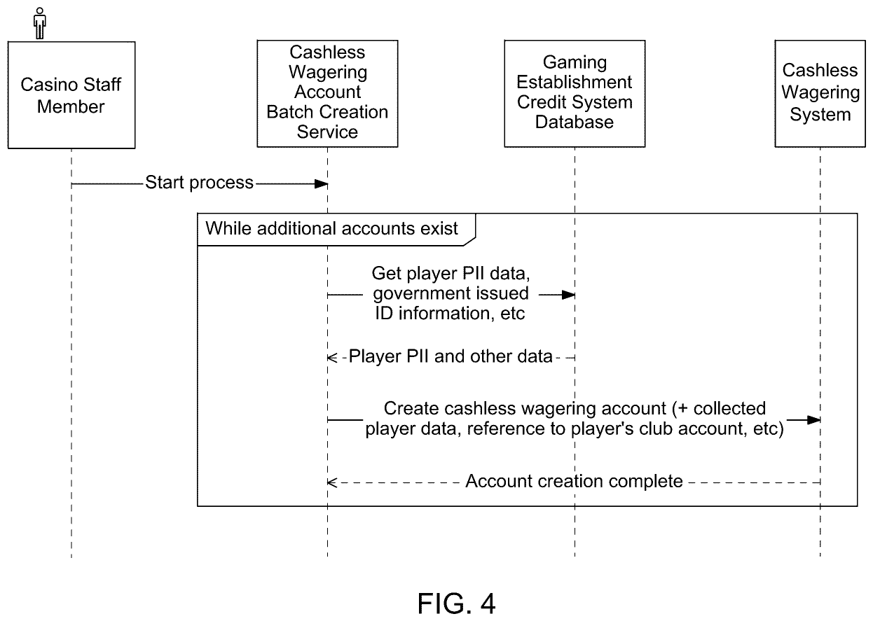

In certain embodiments, following the establishment of a plurality of gaming establishment credit accounts associated with a plurality of users and/or the activation of a plurality of markers associated with a plurality of users (that do not each have certain gaming establishment accounts, such as cashless wagering accounts) and responsive to an occurrence of a bulk account creation event that separately occurs, the system utilizes part or all of the information employed from the establishment of the gaming establishment credit accounts and/or the activation of the markers to create one or more separate and distinct gaming establishment accounts, such as cashless wagering accounts, for these users. In these embodiments, since gaming establishments often maintain a relatively large database of users who have historically signed up for a gaming establishment credit account (and/or taken out one or more markers) without signing up for a cashless wagering account based on the additional efforts required of such users (and in an effort to remove friction from growing the number of users whom lack a cashless wagering account but could benefit from such a cashless wagering account), the system enables the gaming establishment credit system to coordinate with the cashless wagering system (and/or other components of the gaming establishment fund management system) to facilitate a bulk creation of cashless wagering accounts for such users. Accordingly, in certain embodiments, the system performs a batch operation by sharing certain of the enrollment information gathered from multiple users (whom have gaming establishment credit accounts) with the cashless wagering system to create cashless wagering accounts for such users. As such and as seen in FIG. 4 (which illustrates certain interactions involving gaming establishment personnel, such as a casino staff member, that interfaces with a component operable to create cashless wagering accounts in bulk (i.e., the cashless wagering account batch creation service), a database maintained by a gaming establishment credit system and a cashless wagering system), certain embodiments enable the bulk creation of cashless wagering accounts for a plurality of users based on a bulk triggering event that occurs following each of a plurality of users respective enrollments for gaming establishment credit accounts and/or activations of gaming establishment markers.

In certain embodiments, as mentioned above, the completion of the establishment of the gaming establishment account, such as a cashless wagering account, is subject to zero, one or more additional steps required of the user (e.g., the user separately acknowledging that they are signing up for a cashless wagering account and accepting the terms and conditions required for such an account). In these embodiments, the system places the cashless wagering account created into a disabled or inactive state until the user accepts the terms and conditions to enable their account. In certain such embodiments, the system prompts the user to accept the terms and conditions via a message displayed at any suitable device, via an email, via an SMS or text message, and/or via a notification displayed by a mobile device application. In certain other embodiments, the system prompts the user to accept the terms and conditions of the account the next time the user attempts to draw down from their credit account or line of credit. In certain other embodiments, the system prompts the user to accept the terms and conditions via interfacing with a gaming establishment device at an appropriate time, such as prompting the user to accept the terms and conditions the next time the user initiates a wagering session at an EGM (e.g., when accessing a player tracking account at the EGM, an external controlled service window at the EGM presents the user the terms and conditions to accept).

Accordingly, to minimize the amount of time users and gaming establishment personnel need to interact with each other, to minimize the amount of processing resources dedicated to collecting the same information multiple times as well as to reduce the quantity of instances that errors may occur in collecting certain information required by certain jurisdictions, the system of the present disclosure utilizes information previously collected by one component, such as a component of a gaming establishment credit system, in association with the jurisdictional requirement to collect the same (or similar) information by another component, such as a component of a gaming establishment cashless wagering system. That is, based on the amount of overlap involved in information that needs to be collected to enroll a user in a cashless wagering account and separately enroll a user for a gaming establishment credit account (and/or activate a marker from a gaming establishment credit account) and further based on the lack of communication between components that maintain such accounts (which leads to the same user having to input the same information multiple times), the system of the present disclosure harnesses a single input of certain information to enable multiple components to operate independently to achieve different outcomes based on the same inputted information. In other words, in certain instances, the system leverages a gaming establishment credit enrollment process to automate enrolling users into cashless wagering accounts (and/or other types of gaming establishment accounts) as the data requirements for enrolling for a cashless wagering account are relatively close to the data requirements for enrolling for a gaming establishment credit account. Such a configuration results in a more efficient system in which enrolling (or having enrolled) for one gaming establishment account causes the automatic sharing of certain information necessary to enroll for another gaming establishment account which certain users would not otherwise undertake (and not avail themselves of certain benefits realized via the employment of such a gaming establishment account).

In certain embodiments, following the approval of a gaming establishment credit account and the automatic creation of a gaming establishment account, such as a cashless wagering account, based on the data employed to approve the credit account, to request a transfer of an amount of funds via a marker associated with the credit account to the gaming establishment device, a user utilizes a physical instrument (e.g., a smart card or a user issued magnetic striped card which the user utilizes via inserting the card into a card reader associated with the gaming establishment device) to enable the user to identify themselves to the gaming establishment device (and the gaming establishment credit system) and interfaces with the gaming establishment device (or a component associated with the gaming establishment device) to request an electronic transfer of funds from the gaming establishment credit system to the gaming establishment device. In certain embodiments, following the approval of a gaming establishment credit account and the automatic creation of a gaming establishment account, such as a cashless wagering account, based on the data employed to approve the credit account, to request a transfer of an amount of funds via a marker associated with the credit account to the gaming establishment device, the system requires the user to pair a mobile device with the gaming establishment device. For example, to access an amount of funds via a marker, the system requires the user to pair a mobile device (which is executing a gaming establishment mobile device application) with a SMIB (i.e., a component of the gaming establishment patron management system) associated with the EGM and interface with at least the mobile device application to request an electronic transfer of funds from the gaming establishment credit system to the gaming establishment device.

In certain embodiments, following receipt of the user inputted data associated with the determined amount of funds to be accessed via the marker and a confirmation from the user that they approve of the transaction and agree to any terms associated with the marker transaction, the system communicates one or more messages to the gaming establishment credit system to log the user into the gaming establishment credit system (if necessary) and request an activation of the amount of funds to be accessed via the marker of the user. Upon receiving the messages and verifying the request, the gaming establishment credit system proceeds with operating with the gaming establishment fund management system (e.g., a gaming establishment cashless wagering system) to log the user into the automatically created gaming establishment account (described herein as the automatically created cashless wagering account but not otherwise limited to a cashless wagering account) associated with the user (if necessary) and potentially transfer the amount of funds to be accessed via the marker to the gaming establishment account associated with the user (e.g., to the automatically created gaming establishment cashless wagering account associated with the user.)

In certain embodiments, to complete a transfer of an amount of funds accessed via a marker to a gaming establishment account, the gaming establishment credit system determines whether to authorize the activation of the determined amount of funds. In these embodiments, if the gaming establishment credit system determines not to authorize the activation of the determined amount of funds via the marker, the gaming establishment credit system communicates one or more denial messages. In certain embodiments, following the denial, one or more display devices (e.g., display devices of a mobile device and/or the EGM) display a denial of marker activation to the user.

On the other hand, if the gaming establishment credit system determines to authorize the activation of the determined amount of funds via the marker, the gaming establishment credit system updates the amount provided via the marker and communicates an authorization of the requested amount of funds to the gaming establishment fund management system. Upon receiving the authorization, the gaming establishment fund management system updates a balance of a gaming establishment account by the requested amount of funds activated via the marker. In certain embodiments, in association with the transfer, the system communicates a transfer of funds confirmation, wherein one or more display devices display a confirmation of the transfer of the amount of funds from the marker to the gaming establishment account.

In certain embodiments, following the completion of the transfer of an amount of funds associated with the marker to the gaming establishment account, such as the automatically created cashless wagering account associated with a user, the system enables the user to transfer an amount of funds from the gaming establishment account to the EGM. In certain other embodiments, following the completion of the transfer of an amount of funds associated with the marker to the gaming establishment account, such as a cashless wagering account associated with a user, the system automatically initiates a transfer of an amount of funds from the gaming establishment account to the EGM. In these embodiments, rather than the user making one or more inputs to attempt to transfer the amount of funds accessed via the marker to the EGM, the system automatically determines to transfer an amount of funds, such as the amount accessed via the marker, from the gaming establishment account to the EGM.

In these different embodiments, following a determination to transfer an amount of funds from the gaming establishment account to the EGM, a component of the gaming establishment fund management system, such as a server of the cashless wagering system, logs the user into a gaming establishment account associated with the user (if necessary) and requests the determined amount of funds to be transferred from the gaming establishment account to the EGM. In these embodiments, the component of the gaming establishment fund management system, such as a server of the cashless wagering system, determines whether to authorize the transfer of the amount of funds. If the component of the gaming establishment fund management system determines not to authorize the determined amount of funds, the component of the gaming establishment fund management system communicates a denial and, in certain embodiments, displays a denial of funds transfer to the user. On the other hand, if the component of the gaming establishment fund management system determines to authorize the amount of funds, the component of the gaming establishment fund management system updates the gaming establishment account associated with the user and communicates an authorization to the SMIB (and/or the EGM). For example, when funds are transferred from a cashless wagering account to the EGM, the cashless wagering system reduces a balance of the cashless wagering account by the reduced amount of funds. The EGM proceeds with updating a credit balance of the EGM to account for the amount of funds. In certain embodiments, the EGM further proceeds with communicating a transfer of funds confirmation and such a transferred amount of funds is then available for wagering at the EGM.

It should be appreciated that in addition to transferring funds activated via a marker from a gaming establishment credit system to a gaming establishment account and then to a gaming establishment device, such as an EGM, the system enables a transfer of funds from a gaming establishment device, such as an EGM, to a gaming establishment account and then to the gaming establishment credit system to payback or otherwise deactivate a marker.

In certain embodiments, following the use of none, part or all of the transferred amount of funds at the EGM from an activated marker and upon receiving a “cash out” input from the user, part or all of the credit balance of the EGM is transferred to the gaming establishment account independent of any attempt to repay the amount of funds outstanding on any activated markers. In these embodiments, unlike prior systems which required that any amount cashed out from an EGM is automatically applied to repay the amount of funds outstanding on any activated markers, the system of certain embodiments does not mandate that any amount cashed out from an EGM is automatically applied to repay the amount of funds outstanding on any activated markers. Rather, after an amount of funds are cashed out from an EGM, the system enables such cashed out funds to flow to a gaming establishment account, such as a cashless wagering account, thereby reducing user tension by not having to continually activate the marker at each EGM played.

In certain embodiments, following one or more inputs to cash out a credit balance of an EGM to a gaming establishment account, the SMIB (and/or the EGM) operates with the gaming establishment fund management system to transfer the amount of funds of the credit balance of the EGM to the gaming establishment account, such as the automatically created cashless wagering account associated with the user. In certain other embodiments, the system determines to facilitate the transfer of funds from the EGM to the gaming establishment account, such as the automatically created cashless wagering account, independent of any input by the user. In one such embodiment, if the system determines that no activity has occurred for a designated amount of time, as a precautionary measure, the system automatically transfers the credit balance of the EGM from the EGM to the gaming establishment account used to transfer funds to the EGM. In another embodiment, if the system determines that another user is attempting to log onto the EGM, as a precautionary measure, the system automatically transfers the credit balance of the EGM from the EGM to the gaming establishment account used to transfer funds to the EGM.

In these embodiments, after a determination to transfer the credit balance of the EGM from the EGM to a gaming establishment account, the SMIB (and/or the EGM) proceeds with operating with the gaming establishment fund management system to log the player into a gaming establishment account, such as a cashless wagering account associated with the user (or confirm that the user remains logged into the gaming establishment account) and request the determined amount of funds to be transferred from the EGM to the gaming establishment account. Following such a request, the EGM proceeds with updating a credit balance of the EGM to account for the determined amount of funds transferred from the EGM to the gaming establishment account. The gaming establishment fund management system additionally updates the gaming establishment account associated with the user (e.g., the cashless wagering system adds the determined amount of funds to the cashless wagering account) and communicates a confirmation to the SMIB (and/or the EGM). Such a transferred amount of funds are available in the gaming establishment account to be transferred to another gaming establishment device (such as another EGM or a gaming table component) or another gaming establishment account.

It should be appreciated that since the amount of funds of the credit balance of the EGM are not necessarily utilized to pay back any outstanding markers but are transferred from the EGM to a gaming establishment account, the system of the present disclosure reduces friction for the user (i.e., the user does not need to repeatedly reactivate the same marker) and promotes the user transitioning from one EGM to another without having to reactivate funds from their marker (which remain accessible in their gaming establishment account, such as their cashless wagering account). Additionally, by not requiring the automatic repayment of a marker with each and every cash out from an EGM, the system enables the user to make a second withdrawal from the marker without having to satisfy the first withdrawal, thereby providing the user greater control over the funds represented by what is owed on the marker.

In certain embodiments, the system enables the user to utilize part or all of the funds transferred to the gaming establishment account to repay the amount owed on the activated marker. In certain other embodiments, responsive to one or more marker repayment events, the system automatically utilizes part or all of the funds transferred to the gaming establishment account to repay the amount owed on the activated marker. In these embodiments, after a determination to repay part or all of an amount owed on an activated marker, the gaming establishment fund management system operates with the gaming establishment credit system to request an amount of funds to be transferred from the gaming establishment account to the gaming establishment credit system to satisfy part or all of an activated marker. Following such a request (and an approval by the gaming establishment credit system), the gaming establishment fund management system updates the gaming establishment account associated with the user (e.g., the cashless wagering system subtracts the determined amount of funds from the cashless wagering account) and the gaming establishment credit system updates the repayment of the amount owed on the activated marker. In these embodiments, if the marker is paid back in full, the gaming establishment credit system deactivates or retires the marker. On the other hand, if the marker is not paid back in full, the gaming establishment credit system maintains the activated marker and updates the balance owed on the marker.

It should be appreciated that any functionality or process of the present disclosure may be implemented via one or more servers (associated with or independent of any component of any system disclosed herein), a mobile device application, one or more gaming establishment devices (e.g., a gaming device such as an EGM or a non-gaming device such as a point-of-sale terminal of a retailer located within or otherwise associated with a gaming establishment), and/or one or more components of a gaming establishment system (such as a component of a gaming establishment patron management system supported by or otherwise located inside a gaming establishment device and/or a non-gaming establishment device). Accordingly: (i) while certain functions, features or processes are described herein as being performed by one (or more) device (e.g., a server, a mobile device application, a gaming establishment device, a component of a gaming establishment system), such functions, features or processes may alternatively be performed, if applicable, by another such different devices.

In certain embodiments, the above-described embodiments of the present disclosure may be implemented in accordance with or in conjunction with zero, one or more components of one or more systems (e.g., a gaming establishment credit system, a gaming establishment front money handling system, a gaming establishment patron management system, a gaming establishment fund management system, an external funding system and/or a gaming establishment device management system) and/or zero, one or more gaming establishment devices. In these embodiments, such a component of the system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the system and/or the gaming establishment device; (3) accessing memory to configure or reconfigure parameters in the memory according to indicia read from the component of the system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the system and/or the gaming establishment device, while in other embodiments, at least one component of the controller resides outside of the housing of the component of the system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the system and/or the gaming establishment device disclosed herein. In certain embodiments, the at least one memory device resides within the housing of the component of the system and/or the gaming establishment device, while in other embodiments at least one component of the at least one memory device resides outside of the housing of the component of the system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the system and/or the gaming establishment device; (2) associations between configuration indicia read from the component of the system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the system and/or the gaming establishment device to control the component of the system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) uses such a removable memory device in a component of the gaming establishment fund management system to implement at least part of the present disclosure. In other embodiments, part or all of the program code and/or the operating data is downloaded to the at least one memory device of the component of the system and/or the gaming establishment device through any suitable data network described above (such as an Internet or intranet).

The at least one memory device also stores a plurality of device drivers. Examples of different types of device drivers include device drivers for the component of the system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the system and/or the gaming establishment device loads the new device driver from the at least one memory device to enable communication with the new device. For instance, one type of card reader in the component of the system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the system, and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

The at least one output device includes at least one display device configured to display any suitable information. In certain embodiments, the display devices are connected to or mounted on a housing of the component of the system and/or the gaming establishment device. For example, the display devices serve as digital glass configured to display aspects of the gaming establishment device. In various embodiments, the gaming establishment device includes zero, one or more of the following display devices: (a) a central display device; (b) a player tracking display configured to display various information regarding a user's player tracking status; (c) a secondary or upper display device in addition to the central display device and the player tracking display; (d) a credit display configured to display a current quantity of credits, amount of cash, account balance, or the equivalent; and (e) a bet display. In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

In various embodiments, the at least one output device includes a payout device. For example, after the gaming establishment device receives an actuation, the gaming establishment device causes the payout device to provide a payment to the user. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the user following receipt of an actuation of the cashout device, the payout device is configured to cause a payment to be provided to the user in the form of an electronic funds transfer, such as via a direct deposit into a bank account, a casino account, or a prepaid account of the user; via a transfer of funds onto an electronically recordable identification card or smart card of the user; or via sending a virtual ticket having a monetary value to an electronic device of the user.

In certain embodiments, the at least one output device is a sound generating device controlled by one or more sound cards. In one such embodiment, the sound generating device includes one or more speakers or other sound generating hardware and/or software configured to generate sounds, such as by playing music. For example, the gaming establishment device provides dynamic sounds coupled with attractive multimedia images displayed on one or more of the display devices to provide an audio-visual representation or to otherwise display full-motion video with sound to attract users to the gaming establishment device. In certain embodiments, the gaming establishment device displays a sequence of audio and/or visual attraction messages during idle periods to attract potential users to the gaming establishment device. The videos may be customized to provide any appropriate information.

The at least one input device may include any suitable device that enables an input signal to be produced and received by the at least one processor of the component of the system and/or the gaming establishment device. In one embodiment, the at least one input device includes a payment device configured to communicate with the at least one processor of the gaming establishment device to fund the gaming establishment device. In certain embodiments, the payment device includes zero, one or more of: (a) a bill acceptor into which paper money is inserted; (b) a ticket acceptor into which a ticket or a voucher is inserted; (c) a reader or a validator for credit cards, debit cards, or credit slips into which a credit card, debit card, or credit slip is inserted; (d) a player identification card reader into which a player identification card is inserted; or (e) any suitable combination thereof. In one embodiment, the at least one input device includes a payment device configured to enable the gaming establishment device to be funded via an electronic funds transfer, such as a transfer of funds from a bank account. In another embodiment, the gaming establishment device includes a payment device configured to communicate with a mobile device of a user, such as a mobile phone, a radio frequency identification tag, or any other suitable wired or wireless device, to retrieve relevant information associated with that user to fund the gaming establishment device. When the gaming establishment device is funded, the at least one processor determines the amount of funds entered and displays the corresponding amount.

In various embodiments, the at least one input device includes a plurality of buttons that are programmable by the component of the system and/or the gaming establishment device operator to, when actuated, cause the component of the system and/or the gaming establishment device to perform particular functions. For instance, such buttons may be hard keys, programmable soft keys, or icons icon displayed on a display device of the gaming establishment device that are actuatable via a touch screen of the gaming establishment device or via use of a suitable input device of the gaming establishment device. In certain embodiments, the at least one input device includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the gaming establishment device by touching the touch screen at the appropriate locations.

The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

The at least one wired/wireless power distribution component includes components or devices that are configured to provide power to other devices. For example, in one embodiment, the at least one power distribution component includes a magnetic induction system that is configured to provide wireless power to one or more user input devices near the component of the system and/or the gaming establishment device. In one embodiment, a user input device docking region is provided, and includes a power distribution component that is configured to recharge a user input device without requiring metal-to-metal contact. In one embodiment, the at least one power distribution component is configured to distribute power to one or more internal components of the component of the system and/or the gaming establishment device, such as one or more rechargeable power sources (e.g., rechargeable batteries) located at the component of the system and/or the gaming establishment device.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the component of the system and/or the gaming establishment device; detecting the presence and/or identity of various persons (e.g., users, casino employees, etc.), devices (e.g., user input devices), and/or systems within a predetermined proximity to the component of the system and/or the gaming establishment device.

The at least one data preservation component is configured to detect or sense one or more events and/or conditions that, for example, may result in damage to the component of the system and/or the gaming establishment device and/or that may result in loss of information associated with the component of the system and/or the gaming establishment device. Additionally, the data preservation system may be operable to initiate one or more appropriate action(s) in response to the detection of such events/conditions.

The at least one motion/gesture analysis and interpretation component is configured to analyze and/or interpret information relating to detected user movements and/or gestures to determine appropriate user input information relating to the detected user movements and/or gestures. For example, in one embodiment, the at least one motion/gesture analysis and interpretation component is configured to perform one or more of the following functions: analyze the detected gross motion or gestures of a user; interpret the user's motion or gestures (e.g., in the context of a casino game being played) to identify instructions or input from the user; utilize the interpreted instructions/input to advance the game state; etc. In other embodiments, at least a portion of these additional functions may be implemented at a remote system or device.

The at least one portable power source enables the component of the system and/or the gaming establishment device to operate in a mobile environment.

The at least one geolocation module is configured to acquire geolocation information from one or more remote sources and use the acquired geolocation information to determine information relating to a relative and/or absolute position of the component of the system and/or the gaming establishment device. For example, in one implementation, the at least one geolocation module is configured to receive GPS signal information for use in determining the position or location of the gaming establishment device. In another implementation, the at least one geolocation module is configured to receive multiple wireless signals from multiple remote devices and use the signal information to compute position/location information relating to the position or location of the gaming establishment device.

The at least one user identification module is configured to determine the identity of the current user or current owner of the component of the system and/or the gaming establishment device. For example, in one embodiment, the current user is required to perform a login process at the component of the system and/or the gaming establishment device in order to access one or more features. Alternatively, the component of the system and/or the gaming establishment device is configured to automatically determine the identity of the current user based on one or more external signals, such as an RFID tag or badge worn by the current user and that provides a wireless signal to the component of the system and/or the gaming establishment device that is used to determine the identity of the current user. In at least one embodiment, various security features are incorporated into the component of the system and/or the gaming establishment device to prevent unauthorized users from accessing confidential or sensitive information.

The at least one information filtering module is configured to perform filtering (e.g., based on specified criteria) of selected information to be displayed at one or more displays of the component of the system and/or the gaming establishment device.

In various embodiments, the component of the system and/or the gaming establishment device includes a plurality of communication ports configured to enable the at least one processor of the component of the system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, the component of the system and/or the gaming establishment device has a support structure, housing, or cabinet that provides support for a plurality of the input devices and the output devices of the component of the system and/or the gaming establishment device.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor in association with a creation of a gaming establishment credit account associated with a user, cause the processor to:
request identifying information associated with the user from a component of a gaming establishment credit system that maintains the gaming establishment credit account, wherein a first part of the identifying information was provided by the user in association with the creation of the gaming establishment credit account, and
responsive to a receipt of the identifying information associated with the user from the component of the gaming establishment credit system, automatically and independent of the user reproviding at least the first part of the identifying information, create a gaming establishment account associated with the user, wherein the creation of the gaming establishment account is at least partially based on the identifying information communicated from the component of the gaming establishment credit system.

2. The system of claim 1, wherein the gaming establishment account comprises a cashless wagering account.

3. The system of claim 1, wherein the created gaming establishment account is disabled from being transacted against.

4. The system of claim 3, wherein the created gaming establishment account is enabled to be transacted against based on an input received from the user.

5. The system of claim 4, wherein the input is associated with an acceptance of the gaming establishment account.

6. The system of claim 3, wherein the created gaming establishment account is enabled to be transacted against based on an input received independent of the user.

7. The system of claim 1, wherein the gaming establishment credit account is associated with an amount of front money provided by the user.

8. The system of claim 1, wherein funds associated with the gaming establishment credit account are accessible via a gaming establishment marker.

9. The system of claim 1, wherein at least a second part of the identifying information associated with the user was provided by the user prior to the creation of the gaming establishment credit account.

10. A system comprising:
a processor; and
a memory device that stores a plurality of instructions that, when executed by the processor responsive to an occurrence of a gaming establishment account creation event associated with an occurrence of a gaming establishment marker creation event, cause the processor to:
determine if a user associated with the gaming establishment marker creation event is associated with any cashless wagering accounts,
responsive to the determination being that the user associated with the gaming establishment marker creation event is not associated with any cashless wagering accounts:
request identifying information associated with the user from a component of a gaming establishment credit system, the identifying information being at least partially inputted by the user in association with the occurrence of the gaming establishment marker creation event,
responsive to a receipt of the identifying information associated with the user from the component of the gaming establishment credit system, automatically create a cashless wagering account associated with the user, wherein the automatic creation of the cashless wagering account is at least partially based on the identifying information communicated from the component of the gaming establishment credit system, and
communicate data that results in a display, by a display device, of a notification associated with the created cashless wagering account and any created gaming establishment marker based on the occurrence of the gaming establishment marker creation event.

11. The system of claim 10, wherein part of the identifying information associated with the user is provided by the user prior to the gaming establishment marker creation event and not reprovided by the user responsive to the occurrence of the gaming establishment account creation event.

12. A method of operating a system, the method comprising:
in association with a creation of a gaming establishment credit account associated with a user:
requesting, by a processor, identifying information associated with the user from a component of a gaming establishment credit system that maintains the gaming establishment credit account, wherein a first part of the identifying information was provided by the user in association with the creation of the gaming establishment credit account, and
responsive to a receipt of the identifying information associated with the user from the component of the gaming establishment credit system, automatically and independent of the user reproviding at least the first part of the identifying information, creating, by the processor, a gaming establishment account associated with the user, wherein the creation of the gaming establishment account is at least partially based on the identifying information communicated from the component of the gaming establishment credit system.

13. The method of claim 12, wherein the gaming establishment account comprises a cashless wagering account.

14. The method of claim 12, wherein the created gaming establishment account is disabled from being transacted against.

15. The method of claim 14, wherein the created gaming establishment account is enabled to be transacted against based on an input received from the user.

16. The method of claim 15, wherein the input is associated with an acceptance of the gaming establishment account.

17. The method of claim 14, wherein the created gaming establishment account is enabled to be transacted against based on an input received independent of the user.

18. The method of claim 12, wherein the gaming establishment credit account is associated with an amount of front money provided by the user.

19. The method of claim 12, wherein funds associated with the gaming establishment credit account are accessible via a gaming establishment marker.

20. The method of claim 12, wherein at least a second part of the identifying information associated with the user was provided by the user prior to the creation of the gaming establishment credit account.
